(19) United States
(12) Patent Application Publication
(10) Pub. No.: US 2006/0220852 A1
(43) Pub. Date: Oct. 5, 2006

(54) Beach/tote bags

(76) Inventor: Wilfred Thomas Haun, Brandon, FL (US)

Correspondence Address: WILFRED HAUN, 702 CALM DR, BRANDON, FL, 33511, US

(21) Appl. No.: 10/992,068

(22) Filed: Mar. 16, 2005

(51) Int. Cl. G08B 13/14

(52) U.S. Cl. 340/571

(57) ABSTRACT

A Beach and/or Tote Bag that has an alarm that sounds when it is pick up after the alarm is set to prevent a thief from taking it.

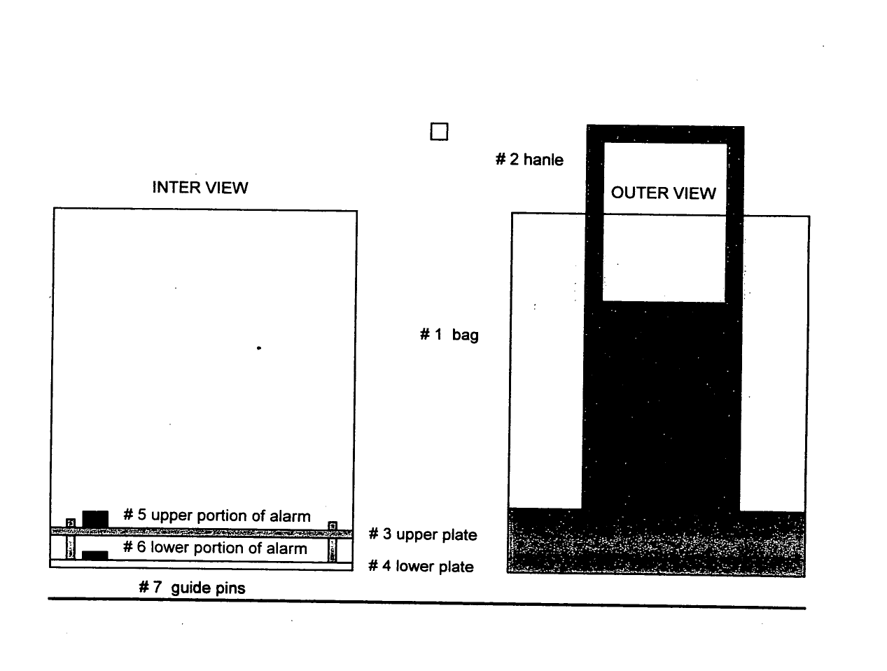

This invention pertains to a beach and/or tote bags which is used to store person property while in public places. The primary function of the alarm in a beach and/or tote bag is when the alarm is activated it will alert those people around the area that someone is trying to take the bag. The Beach and/or Tote Bag has been designed in this way. There are two levels of plates attached to the cloth on which the alarms are attached. These plates are attached to the bag in a way that they will separate when the Beach and/or Tote Bag has been lifted from it resting point. With the alarm having been set, at the time that the bag is lifted the audible alarm will sound to alert people that a thief is attempting to take the bag. Type of alarm can be manual, remote and/or key pad. The alarm system is run be batteries that is in the top portion of the upper alarm.

Back ground on how we came up with this ideal.

We were on the beach in Clearwater Florida and a young couple was reporting the theft of the property to a police man. They were very upset about losing their valuables, meaning they would have the hassle of canceling all their credit cards. They would have to wait for new cards and they would have to go apply and receive new driver license. If there was any of the new gift cards that are so prevalent today that companies like Home Depot, Lowes, Office Depot, even Walmart gives out, would be lost. Having lost items in the past, I know the feeling the despair to lose the cards, cash, pictures of grandkids and cash cards. If anything can be done to stop just some of the thief, it is worth it. Because we witness this, we started to design the Beach Safe Bag. Starting off buying cloth for the bag, wood for the plates and alarms. After making about eight bags, we decided on the last design and size the bag would be.

We are excited about helping to keep valuables out of the hands of the thief and help people to feel safer with their thing.

Some Patent search found . . .

U.S. Pat. No. 919,385 Suit Case, alarm activated when brush contact the lever that drops when case is picked up. Contacts in handle will make alarm to sound.

U.S. Pat. No. 1,148,773 Hand Bag, with hinged jaws or doors to be opened to afford access to the interior.

U.S. Pat. No. 1,730,745 Hand Bag, handle of the bag is cut or severed in anticipation of wresting the bag from the carrier.

U.S. Pat. No. 2,758,296 Mechanism Box, level on bottom will move when box is moved activating levers and springs to make to alarm sound.

U.S. Pat. No. 3,701,140 Purse, alarm response to a sudden pull or jerking force exerted on the purse handle or carrying strap.

U.S. Pat. No. 3,893,096 Handbag, which are closed by a clasp. Alarm sounds when unauthorized opening of the handbag.

U.S. Pat. No. 4,117,468 Briefcases, The proprietary is able to energize the alarm generating means by pushing one or more exterior push-buttons.

U.S. Pat. No. 4,118,692 Bag Alarm, A bag alarm device utilizes a bar slide ably affixed to the interior surface of a closure flap and sounds when opened.

U.S. Pat. No. 4,155.079 Suitcase, If the case is taken from owner's hand causes a plug to be separated from a jack to supply power to an alarm.

U.S. Pat. No. 4,204,202 Attaché case, Has handle fastened to the body by two sets of metal studs and two locks.

U.S. Pat. No. 4,272,763 Attaché case, Mirco switches mounted in the handle.

U.S. Pat. No. 4,728,937 Suitcase, Push bottom switches, potential electric shock.

U.S. Pat. No. 5,027,105 Case, motion detectors in brief case.

U.S. Pat. No. 5,041,185 Golf Bag

This invention pertains to a Beach/Tote Bag which is used to store personal property while in public places. The primary function is an alarm that sound to alert those people in the area that a thief is stealing the bag. This has two purposes, the thief should drop the bag and all those in the area will look and make it easier to identify the thief. Alarm activates when bag is picked up to let the two plates separate, so the alarm also separates making the sound to alert others.

### BRIEF DESCRIPTION OF DRAWINGS

Inter view show the parts of the bag.

Outer view show the look of the bag.

How it is made, we start with a cloth material and make the bag # 1. Taking the bottom plate # 4, we attach the guide pins # 7, to it and then attach the bottom plate #4 that lower portion of the alarm # 6 is on, to the bottom portion of the bag #1. Attach the upper portion of the alarm # 3 to the upper plate # 5, then attach the plate to a lip that has been made in the cloth bag to hold upper plate # 5 in position to make the alarm separate to activate it. Also, this alarm system can be made in the same manor so that it would be able to be mounted in other bags. It would be made the same way except that the height of the bag would change.

1. I, Wilfred Haun claim that this application is for a Beach and/or Tote Bag which is to protect valuables when in public places.
How it works is, after putting your valuables in the bag the alarm is turned on so that when the bag is lifted from it's resting place the alarm will sound to alert those that in the area that the bag is being taken by an unauthorized person. This has two purposes, first to let people know the Beach/Tote Bag is being taken and second to draw attention so that the person can be identified by the people that has looked due to the alarm sounding.
